(19) United States
(12) Patent Application Publication
(10) Pub. No.: US 2011/0258701 A1
(43) Pub. Date: Oct. 20, 2011

(54) Protecting A Virtualization System Against Computer Attacks

(75) Inventors: Alen Cruz, Tampa, FL (US); Paul F. Beraud, III, Parrish, FL (US)

(73) Assignee: Raytheon Company, Waltham, MA (US)

(21) Appl. No.: 12/759,751

(22) Filed: Apr. 14, 2010

(51) Int. Cl. G06F 9/455; G06F 9/445; G06F 21/00

(52) U.S. Cl. 726/23; 718/1; 717/174

(57) ABSTRACT

In certain embodiments, protecting a virtualization system against computer attacks comprises facilitating operation of hypervisors comprising operation zone hypervisors and one or more forensic hypervisors. Each hypervisor operates on a corresponding physical machine, and each operation zone hypervisor manages one or more virtual machines. An assurance procedure is initiated for the hypervisors. At least one virtual machine of a first operation zone hypervisor is moved to a forensic hypervisor to analyze the potential attack. The first operation zone hypervisor is cleaned.

### TECHNICAL FIELD

This invention relates generally to the field of computing systems and more specifically to protecting a virtualization system against computer attacks.

### BACKGROUND

Computer systems, such as data centers, may be susceptible to cyber attacks. Cyber attacks may yield undesirable consequences, for example, reducing the capabilities of a computer system, allowing unauthorized access and/or control of the computer system, rendering the computer system unusable, denying service to authorized users, and/or other undesirable consequence. Computer systems typically use security techniques to handle the cyber attacks.

### SUMMARY OF THE DISCLOSURE

In accordance with the present invention, disadvantages and problems associated with previous techniques for preventing attacks may be reduced or eliminated.

In certain embodiments, protecting a virtualization system against computer attacks comprises facilitating operation of hypervisors comprising operation zone hypervisors and one or more forensic hypervisors. Each hypervisor operates on a corresponding physical machine, and each operation zone hypervisor manages one or more virtual machines. An assurance procedure is initiated for the hypervisors. At least one virtual machine of a first operation zone hypervisor is moved to a forensic hypervisor to analyze the potential attack. The first operation zone hypervisor is cleaned.

Certain embodiments of the invention may provide one or more technical advantages. A technical advantage of one embodiment may be that a platform manager may perform an assurance procedure for two or more hypervisors. The platform manager may be protected from attacks by a barrier such as a firewall. Another technical advantage of one embodiment may be that the platform manager may operate in a proactive mode and/or a reactive mode. In the proactive mode, the assurance procedure is initiated according to an assurance procedure schedule. In the reactive mode, the assurance procedure is initiated in response to detecting a potential attack.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 illustrates an example of a system in which a virtualization system may be protected against computer attacks; and

FIG. 2 illustrates an example of a method for protecting a virtualization system against computer attacks.

### DETAILED DESCRIPTION OF THE DRAWINGS

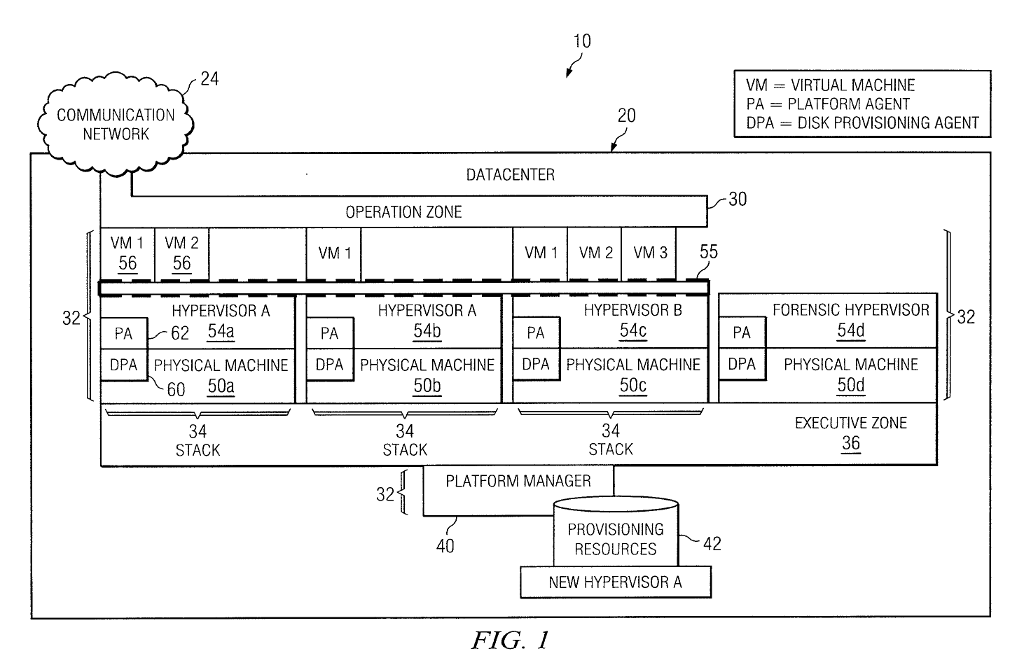

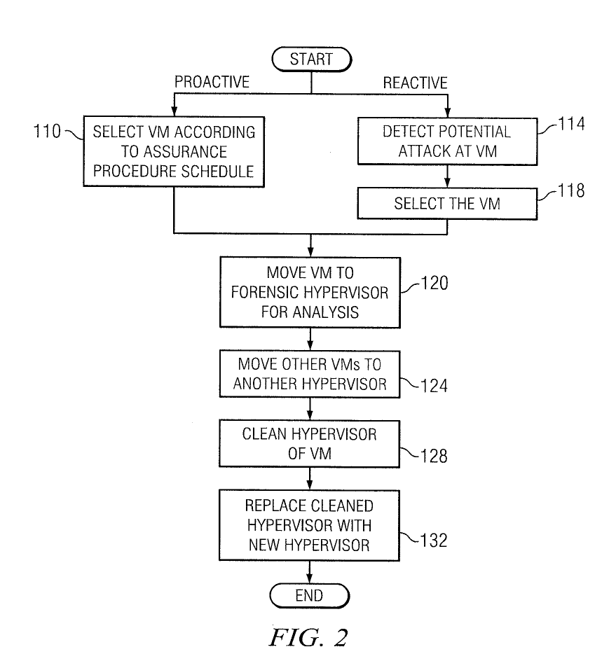

Embodiments of the present invention and its advantages are best understood by referring to FIGS. 1 and 2 of the drawings, like numerals being used for like and corresponding parts of the various drawings.

FIG. 1 illustrates an example of a system 10 in which a virtualization system may be protected against computer attacks. In the illustrated example, system 10 includes a data center 20 in communication with and coupled to a communication network 24. Data center 20 includes an operation zone 30, a virtualization system 32, an executive zone 36, a platform manager 40, and one or more provisioning resources 42. Virtualization system includes one or more stacks 34 and platform manager 40. A stack 34 (34a-d) includes a physical machine 50 (50a-d), a hypervisor 54 (54a-d), and one or more virtual machines 56. Devices of the stack 34 may be regarded as corresponding to each other. A physical machine 50 (50a-b) includes a disc provisioning agent (DPA) 60 (60a-d), and a hypervisor 54 (54a-d) includes a platform agent (PA) 62 (62a-d). Hypervisors 54 include operation zone hypervisors 54a-c and one or more forensic hypervisors 54d.

In certain embodiments, virtualization system 32 may be protected against computer attacks. In the embodiments, platform manager 40 may initiate an assurance procedure for the hypervisors 54. For example, platform manager 40 may move a virtual machine 56 of a first operation zone hypervisor 54a to forensic hypervisor 54d for analysis and then clean first operation zone hypervisor 54a.

In certain embodiments, communication network 24 allows components such as data center 20 to communicate with other components. A communication network may comprise all or a portion of one or more of the following: a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, other suitable communication link, or any combination of any of the preceding.

In certain situations, data center 20 may receive a computer attack from communication network 24. A computer attack may be any unauthorized action performed on a computing system that yields undesirable results, and may be performed by, for example, malicious software. Examples of undesirable results include reduced or unusable capabilities of a computer system, unauthorized access and/or control of the computer system, denial of service to authorized users, and/or other unwanted consequence. Examples of malicious software include computer viruses, worms, Trojan horses, root kits, spyware, adware, crime ware, and/or other malicious and/or unwanted software.

In certain embodiments, operation zone 30 allows virtualization system 32 to communicate with communication network 24. Operation zone 30 may include one or more interfaces that allow messages to be communicated between virtualization system 32 and communication network 24. In certain embodiments, operation zone 20 may have the ability to protect against certain types of, but not all, computer attacks.

In certain embodiments, virtualization system 32 allows for a physical machine 50 to appear as different virtual machines 56 to devices of communication network 24 and for multiple physical machines 50 to appear as a single virtual machine 56. Virtualization system 32 may facilitate operation of hypervisors 54 to manage operation of the virtual machines 56 on a physical machine 50. A physical machine 50 that supports virtual machines 56 may be regarded as the physical machine 50 that corresponds to the virtual machines 56. Similarly, virtual machines 56 that are supported by a physical machine 50 may be regarded as the virtual machines 56 corresponding to physical machine 50.

A physical machine 50 may be any suitable computing system that can support one or more virtual machines 56. Examples of computing systems include physical servers of a data center or a server center. Physical machine 50 may include, for example, one or more interfaces (e.g., an network interface), one or more integrated circuits (ICs), one or more storage devices (e.g., a memory or a cache), a network interface controller (NIC), and/or one or more processing devices (e.g., a central processing unit (CPU)).

Disc provisioning agent 60 may allow platform manager 32 and/or a user of platform manager 40 to control physical machine 50. In certain embodiments, disc provisioning agent 60 may be used to clean a stack 34, for example, in response to an instruction from platform manager 40. Cleaning a machine may include removing virtual machines 56, removing the hypervisor 54, loading a clean hypervisor, and/or performing other suitable operation. Disc provisioning agent 60 instruments physical machine 50 for disc-level provisioning. Disc provisioning agent 62 may use any suitable software for cleaning a disc, e.g., NORTON GHOST from SYMANTEC CORPORATION and ACRONIS BACK UP AND RECOVERY from ACRONIS, INC.

A virtual machine 56 may support a server (e.g., a web or mail server) such that the server has the appearance and capabilities of running on its own physical machine 50. In certain embodiments, a server on a virtual machine 56 may process a request sent from a requesting client and send a response to the request back to the requesting client. In certain embodiments, a virtual machine 56 may be assigned or configured with a network layer address (e.g., an IP address). In certain embodiments, a particular virtual machine 56 may manage other virtual machines 56.

Hypervisor 54 may run physical machines 50 to host and execute virtual machines 56. Hypervisor 54 allows physical machine 50 to appear as virtual machines 56 to communication network 54. In certain embodiments, hypervisor 54 may allocate use of a physical machine 50 to a virtual machine 56. Hypervisor 54 may include any suitable virtualization software, for example, VSPHERE from VMWARE, INC. and XENSERVER FROM CITRIX SYSTEMS INC.

Hypervisors 54 may include one or more operation zone hypervisors 54a-c and one or more forensic hypervisors 54d. An operation zone hypervisor 54a-c is serviced by operation zone 30 in order to communicate with communication network 24. Forensic hypervisor 54d analyzes suspected virtual machines 56 subjected to a potential attack. Forensic hypervisor 54d may analyze a suspect virtual machine 56 in any suitable manner. For example, forensic hypervisor 54d may compare the suspected virtual machine 56 with a standard virtual machine 56 that is operating appropriately. If there are differences in operation, for example, differences between the outputs of the virtual machines 56, the suspected virtual machine 56 may be infected. In another example, forensic hypervisor 54d may allow the suspected virtual machine 56 to continue to communication with communication network 24 and monitor the communication. Forensic hypervisor 54d may be able to identify the source of the attack.

Other examples of analysis include determining if the potential attack is an actual attack, the origin of the attack, the type of the attack, and/or other suitable information describing the attack. Examples of software that may be used to analyze a potential attack include ETHEREAL SOFTWARE FROM ETHEREAL INC.

In certain embodiments, forensic hypervisor 54d is not serviced by operation zone 30 and thus does not communicate with communication network 24. Forensic hypervisor 54 communicates with platform manager 40 through executive zone 36.

Platform agent 62 manages a hypervisor 54 to facilitate prevention of computer attacks. Platform agent 62 may perform any suitable operations. For example, platform agent 62 may monitor the behavior of hypervisor 54 to detect potential attacks. A potential attack may be indicated by behavior that may indicate that an attack might or is occurring. Potential attacks may be detected in any suitable manner, for example, platform agent 62 may detect abnormal behavior. Examples of abnormal behavior include unexpected traffic, unexpected file changes, more than expected activity, and/or other unexpected behavior. If platform agent 62 detects a potential threat, platform agent 62 may report the behavior to platform manager 40. As another example, platform agent 62 may recognize an attack by using known attack signatures.

In certain embodiments, in response to instructions by platform manager 40, platform agent 62 may also perform operations to respond to a potential attack. In the embodiments, platform agent 62 may clean, for example, a hypervisor 54 and/or configure the cleaned hypervisor 54. Platform agent 62 may also move a virtual machine 56 from one hypervisor 54 to another hypervisor 54 in response to an instruction by platform manager 40. The new hypervisor may be ready to accept new virtual machines 56.

In certain embodiments, executive zone 36 operates as a barrier that prevents a potential attack from reaching platform manager 40. For example, executive zone 36 may include a firewall.

In certain embodiments, platform manager 40 may facilitate operation of hypervisors 54. Platform manager 40 may initiate an assurance procedure for the hypervisors. An assurance procedure may be used to reduce the probability of a potential attack causing undesirable results. An example of an assurance procedure is described with reference to FIG. 2.

In certain embodiments, platform manager 40 may move a virtual machine 56 of a first operation zone hypervisor 54a to forensic hypervisor 54d for analysis and then clean first operation zone hypervisor 54a with the help of a disc provisioning agent 60. In certain embodiments, platform manager 40 may generate a third operation zone hypervisor 54e using provisioning resources 42 and install third operation zone hypervisor 54e on the physical machine 50a corresponding to the first operation zone hypervisor 54a.

In certain embodiments, platform manager 40 manages operations to protect virtualization system 32 against computer attacks. For example, platform manager 40 may instruct platform agent 62 to monitor hypervisors 54, move a virtual machine 56, and/or configure a hypervisor 54 after a cleaning. Platform manager 40 may instruct a disc provisioning agent 60 to clean a stack 34. Platform manager 40 may also generate new hypervisors 54 to replace hypervisors that may have been subject to a potential attack. In certain embodiments, platform manager 40 may provide external interfaces to a management system. Platform manager 40 may also manage provisioning resources 42.

Provisioning resources 42 may include any suitable resources used to provision stacks 34. Examples of such resources include hypervisor disc images that are used to generate a new hypervisor 54.

FIG. 2 illustrates an example of a method for protecting a virtualization system against computer attacks. Platform manager 40 may perform the method in a proactive mode and/or reactive mode. In the proactive mode, the assurance procedure is initiated according to an assurance procedure schedule. An assurance procedure schedule may indicate when the assurance procedure is to be performed and/or on which virtual machines 56 the assurance procedure is to be performed. For example, an assurance procedure schedule may indicate that the procedure is to be performed at every time period, where the time period is a value selected from a range of for example 10 to 15 hours, such as 12 hours. As another example, an assurance procedure schedule may indicate that the procedure is to be performed at random intervals. In the example, at least one virtual machine 56 of operation zone hypervisor 54a is selected according to the assurance procedure schedule at step 110. The method then proceeds to step 120.

In the reactive mode, the assurance procedure is initiated in response to detecting a potential attack. In the example, a potential attack is detected on at least one virtual machine 56 of operation zone hypervisor 54a at step 110. In certain embodiments, a platform agent 62 may detect the potential attack. The at least one virtual machine 56 subject to the potential attack is selected at step 118. The method then proceeds to step 120.

A selected virtual machine 56 of operation zone hypervisor 54a is moved to forensic hypervisor 54d at step 120 for analysis. In certain embodiments, platform manager 40 may invoke a load-balancing feature of the first operation zone hypervisor to move the virtual machine 56. For example, a load-balancing feature of virtualization software may be invoked. The load-balancing feature may move a virtual machine 56 from one hypervisor 54 to another hypervisor 54 while maintaining communication between the virtual machine 56 and communication network 24.

One or more other virtual machines of operation zone hypervisor 54a are moved to operation zone hypervisor 54c at step 124. Operation zone hypervisor 54c may be substantially similar to operation zone hypervisor 54a and able to accommodate the other virtual machines 56.

Operation zone hypervisor 54a is cleaned at step 128. In certain situations, disc provisioning agent 60 may be used to clean operation zone hypervisor 54a. The cleaned operation zone hypervisor is replaced at step 132. In certain embodiments, platform manager 40 may generate a third operation zone hypervisor and install the third operation zone hypervisor on a physical machine corresponding to the first operation zone hypervisor. The method then ends.

Modifications, additions, or omissions may be made to the systems and apparatuses disclosed herein without departing from the scope of the invention. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods disclosed herein without departing from the scope of the invention. The methods may include more, fewer, or other steps. Additionally, steps may be performed in any suitable order.

A component of the systems and apparatuses disclosed herein may include an interface, logic, memory, and/or other suitable element. An interface receives input, sends output, processes the input and/or output, and/or performs other suitable operation. An interface may comprise hardware and/or software.

Logic performs the operations of the component, for example, executes instructions to generate output from input. Logic may include hardware, software, and/or other logic. Logic may be encoded in one or more tangible media and may perform operations when executed by a computer. Certain logic, such as a processor, may manage the operation of a component. Examples of a processor include one or more computers, one or more microprocessors, one or more applications, and/or other logic.

In particular embodiments, the operations of the embodiments may be performed by one or more computer readable media encoded with a computer program, software, computer executable instructions, and/or instructions capable of being executed by a computer. In particular embodiments, the operations of the embodiments may be performed by one or more computer readable media storing, embodied with, and/or encoded with a computer program and/or having a stored and/or an encoded computer program.

A memory stores information. A memory may comprise one or more non-transitory, tangible, computer-readable, and/or computer-executable storage media. Examples of memory include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or other computer-readable medium.

Components of the systems and apparatuses disclosed may be coupled by any suitable communication network. A communication network may comprise all or a portion of one or more of the following: a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, other suitable communication link, or any combination of any of the preceding.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure, as defined by the following claims.

What is claimed is:

1. A method comprising:
facilitating, by a platform manager, operation of a plurality of hypervisors comprising a plurality of operation zone hypervisors and one or more forensic hypervisors, each hypervisor operating on a corresponding physical machine, each operation zone hypervisor managing one or more virtual machines;
initiating an assurance procedure for the hypervisors;
moving at least one virtual machine of a first operation zone hypervisor to a forensic hypervisor to analyze the potential attack; and
cleaning the first operation zone hypervisor.

2. The method of claim 1, the initiating an assurance procedure for the hypervisors further comprising:
detecting a potential attack; and
initiating the assurance procedure in response to detecting the potential attack.

3. The method of claim 1, the initiating an assurance procedure for the hypervisors further comprising:
initiating the assurance procedure according to an assurance procedure schedule.

4. The method of claim 1, the moving at least one virtual machine further comprising:
invoking a load-balancing feature of the first operation zone hypervisor to move the at least one virtual machine.

5. The method of claim 1, the moving at least one virtual machine further comprising:
analyzing the potential attack to determine if the potential attack is an actual attack.

6. The method of claim 1, further comprising:
moving one or more other virtual machines of the first operation zone hypervisor to a second operation zone hypervisor.

7. The method of claim 1, further comprising:
generating a third operation zone hypervisor; and
installing the third operation zone hypervisor on a physical machine corresponding to the first operation zone hypervisor.

8. The method of claim 1, further comprising:
preventing, by an executive zone barrier, the potential attack from reaching the platform manager.

9. One or more non-transitory computer readable media, when executed by one or more processors, configured to:
facilitate, using a platform manager, operation of a plurality of hypervisors comprising a plurality of operation zone hypervisors and one or more forensic hypervisors, each hypervisor operating on a corresponding physical machine, each operation zone hypervisor managing one or more virtual machines;
initiate an assurance procedure for the hypervisors;
move at least one virtual machine of a first operation zone hypervisor to a forensic hypervisor to analyze the potential attack; and
clean the first operation zone hypervisor.

10. The media of claim 9, configured to initiate an assurance procedure for the hypervisors by:
detecting a potential attack; and
initiating the assurance procedure in response to detecting the potential attack.

11. The media of claim 9, configured to initiate an assurance procedure for the hypervisors by:
initiating the assurance procedure according to an assurance procedure schedule.

12. The media of claim 9, configured to move at least one virtual machine by:
invoking a load-balancing feature of the first operation zone hypervisor to move the at least one virtual machine.

13. The media of claim 9, configured to move at least one virtual machine by:
analyzing the potential attack to determine if the potential attack is an actual attack.

14. The media of claim 9, configured to:
move one or more other virtual machines of the first operation zone hypervisor to a second operation zone hypervisor.

15. The media of claim 9, configured to:
generate a third operation zone hypervisor; and
install the third operation zone hypervisor on a physical machine corresponding to the first operation zone hypervisor.

16. The media of claim 9, configured to:
prevent, using an executive zone barrier, the potential attack from reaching the platform manager.

17. An apparatus comprising:
one or more non-transitory computer readable media storing one or more instructions; and
one or more processors configured execute the instructions to:
facilitate, using a platform manager, operation of a plurality of hypervisors comprising a plurality of operation zone hypervisors and one or more forensic hypervisors, each hypervisor operating on a corresponding physical machine, each operation zone hypervisor managing one or more virtual machines;
initiate an assurance procedure for the hypervisors;
move at least one virtual machine of a first operation zone hypervisor to a forensic hypervisor to analyze the potential attack; and
clean the first operation zone hypervisor.

18. The apparatus of claim 17, configured to initiate an assurance procedure for the hypervisors by:
detecting a potential attack; and
initiating the assurance procedure in response to detecting the potential attack.

19. The apparatus of claim 17, configured to initiate an assurance procedure for the hypervisors by:
initiating the assurance procedure according to an assurance procedure schedule.

20. The apparatus of claim 17, configured to move at least one virtual machine by:
invoking a load-balancing feature of the first operation zone hypervisor to move the at least one virtual machine.
